(19) United States
(12) Patent Application Publication
(10) Pub. No.: US 2017/0300673 A1
(43) Pub. Date: Oct. 19, 2017

(54) INFORMATION APPARATUS AND METHOD FOR AUTHORIZING USER OF AUGMENT REALITY APPARATUS

(71) Applicant: Brillio LLC, Jersey City, NJ (US)

(72) Inventors: Renji Kuruvilla Thomas, Bangalore (IN); Gaurav Jain, Bangalore (IN); Puneet Gupta, Bangalore (IN); Karthik Gopalakrishnan Vinmani, Bangalore (IN)

(21) Appl. No.: 15/195,848

(22) Filed: Jun. 28, 2016

(30) Foreign Application Priority Data
Apr. 19, 2016 (IN) 201641013644

(51) Int. Cl. G06F 21/31; G06T 19/00; G06F 3/033

(52) U.S. Cl. CPC G06F 21/31; G06F 3/033; G06T 19/006

(57) ABSTRACT

Embodiments herein provide a computer-implement method for authorizing an object and a user of an augment reality apparatus. The method includes detecting, by an information apparatus, the object pointed by the augment reality apparatus. Further, the method includes determining, by the information apparatus, an authorization level based on a user key and an object key, wherein the authorization level identifies a role of the user and information about the object to be published based on the role of the user. Further, the method includes causing, by the information apparatus, to display the information associated with the object based on the role of the user on the augment reality apparatus.

### TECHNICAL FIELD

The embodiments herein relate to augmented reality, and more specifically, relate to an information apparatus and method for authorizing a user of an augment reality apparatus. The present application is based on, and claims priority from an Indian Application Number 201641013644 filed on 19 Apr. 2016, the disclosure of which is hereby incorporated by reference.

### BACKGROUND

Augmented Reality includes techniques for displaying virtual objects superimposed over an image of a real place. For example, the image can be a view of a street that includes a restaurant and this reality is augmented by adding name of the restaurant superimposed over the image. Further, information such as menus, reviews, or the like can be superimposed over the image. Smartphone applications have been proposed or developed which allow users to point their camera towards a location and view the location on a display screen of the Smartphone. The application obtains data about the location, such as restaurant names, etc. and then augments the reality displayed on the display screen with the names, menus, reviews, etc.

In conventional methods and systems, in an augmented reality session, when a user points their camera towards an object, the information pertaining to the object is augmented on the object and is displayed to the user. Consider a scenario in which there is more than one user pointing their respective cameras towards the same object. The same information pertaining to the object is displayed to all the users. Thus, there is no provision for managing amount of information to be displayed to the user based on a role of the user. Further, there is no control of selecting a type of information that can be displayed to each user.

### SUMMARY

The principal object of the embodiments herein is to provide an information apparatus and a computer-implement method for authorizing a user of an augment reality apparatus.

Another object of the embodiment herein is to provide a method for detecting, by the information apparatus, the object pointed by the augment reality apparatus.

Another object of the embodiment herein is to provide a method for determining, by the information apparatus, an authorization level based on a user key and an object key, where the authorization level identifies a role of the user and information about the object to be published based on the role of the user.

Another object of the embodiment herein is to provide a method for causing, by the information apparatus, to display the information associated with the object based on the role of the user on the augment reality apparatus.

The principal object of the embodiments herein is to provide an information apparatus and a computer-implement method for authorizing a user of an augment reality apparatus. The method includes detecting, by an information apparatus, the object pointed by the augment reality apparatus. Further, the method includes determining, by the information apparatus, an authorization level based on a user key and an object key, wherein the authorization level identifies a role of the user and information about the object to be published based on the role of the user. Further, the method includes causing, by the information apparatus, to display the information associated with the object based on the role of the user on the augment reality apparatus.

In an embodiment, determining the authorization level based on the user key and the object key includes mapping the user key to a user key authorization level. Further, the method includes mapping the object key to an object key authorization level. Further, the method includes determining the authorization level based on the user key authorization level and the object key authorization level.

In an embodiment, the user key is dynamically generated by the information apparatus after authenticating the user, wherein the user key is generated based on at least one a user identifier, a user behavior, and information of the object required by the user.

In an embodiment, the user key is dynamically changed with a new user key within an augment reality session.

In an embodiment, the object key is dynamically generated by the information apparatus after recognizing the object pointed by the augment reality apparatus, wherein the object key is generated based on at least one of an object identifier and information of the object.

In an embodiment, the object key is dynamically changed with a new object key within an augment reality session.

Another object of the embodiments herein is to provide an apparatus for authorizing a user of an augment reality apparatus. The information apparatus includes an authentication engine configured to authenticate the user of the augment reality apparatus. Further, the information apparatus includes an object detector and recognizer configured to detect an object pointed by the augment reality apparatus. Further, the information apparatus includes an authorization engine configured to determine an authorization level based on a user key and an object key, where the authorization level identifies a role of the user and information about the object to be published based on the role of the user. Further, the information apparatus includes an overlay manager unit configured to cause to display the information associated with the object based on the role of the user on the augment reality apparatus.

Another object of the embodiments herein is to provide a computer program product comprising computer executable program code recorded on a computer readable non-transitory storage medium. The computer executable program code when executed causing the actions including detecting, by an information apparatus, the object pointed by the augment reality apparatus. Further, the computer executable program code when executed causing the actions including determining, by the information apparatus, an authorization level based on a user key and an object key, wherein the authorization level identifies a role of the user and information about the object to be published based on the role of the user. Further, the computer executable program code when executed causing the actions including causing, by the information apparatus, to display the information associated with the object based on the role of the user on the augment reality apparatus.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates a system for authorizing a user of an augment reality apparatus, according to an embodiment as disclosed herein;

FIG. 2 is an example illustration for authorizing a user of an augment reality apparatus, according to an embodiment as disclosed herein;

FIG. 3 is a flow diagram illustrating various operations for generating and sending a user key to an authorization engine, according to an embodiment as disclosed herein;

FIG. 4 is a flow diagram illustrating various operations for generating and sending an object key to an authorization engine, according to an embodiment as disclosed herein;

FIG. 5a is a flow diagram illustrating a method for authorizing a user of an augment reality apparatus, according to an embodiment as disclosed herein;

FIG. 5b is a flow diagram illustrating a method for determining an authorization level based on a user key and an object key, according to an embodiment as disclosed herein;

FIG. 6 is an example illustration for dynamically changing authorization level of a user for selecting information to be displayed on an augment reality apparatus, according to an embodiment as disclosed herein;

FIGS. 7a-7d is an example illustration in which a guest user and a pool manager viewing a swimming pool are displayed with information associated with a swimming pool based on a role of the guest user and the pool manager, according to an embodiment as disclosed herein; and

FIG. 8 illustrates a computing environment implementing an information apparatus and a computer-implement method for authorizing a user of an augment reality apparatus, according to an embodiment disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Accordingly the embodiments herein achieve an information apparatus and a computer-implement method for authorizing a user of an augment reality apparatus. The method includes detecting the object pointed by the augment reality apparatus. Further, the method includes determining an authorization level based on a user key and an object key, wherein the authorization level identifies a role of the user and information about the object to be published based on the role of the user. Further, the method includes causing to display the information associated with the object based on the role of the user on the augment reality apparatus.

In conventional systems and methods, one or more users pointing their cameras towards the object are displayed with the same information pertaining to the object.

Unlike conventional systems and methods, the proposed method provides relevant or role based augmented information of the same object to different users. The information can be selected based on access restrictions to the different users or based on the authorization level of the users. In an example, selective augmented information of the same object can be displayed to different users based on an access level or roles of the users by mapping user-key and object-keys. In an example, manager or a superior person has access to view entire information pertaining to the object whereas normal employee has restricted access to view the information pertaining to the object.

Unlike conventional systems and methods, the proposed method can be used to dynamically change the access level or role of the users to select the extent of information to be displayed to the users. The access level and the role of the users can be changed within the augment reality session or across the augment reality sessions.

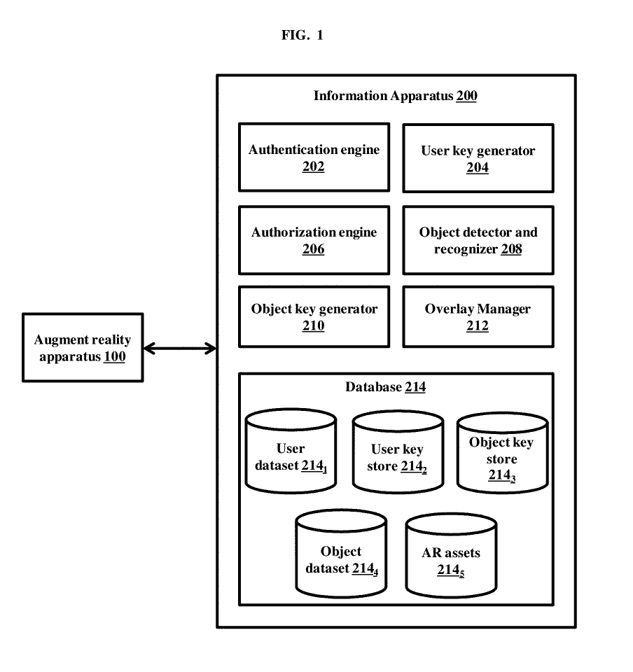

Referring now to the drawings, and more particularly to FIGS. 1 through 8, where similar reference characters denote corresponding features consistently throughout the figures, there are shown preferred embodiments.

FIG. 1 is a system for authorizing a user of an augment reality apparatus 100, according to an embodiment as disclosed herein. In an embodiment, the system includes the augment reality apparatus 100 and an information apparatus 200. The augment reality apparatus 100 can be, for example, a laptop, a desktop computer, a mobile phone, a smart phone, Personal Digital Assistants (PDAs), a tablet, a phablet, or the like. In an embodiment, the information apparatus 200 can be within the augment reality apparatus 100. In another embodiment, the information apparatus 200 can be a server. In an embodiment, the information apparatus 200 includes an authentication engine 202, a user key generator 204, an authorization engine 206, an object detector and recognizer 208, an object key generator 210, an overlay manager 212, and a database 214. The database 214 includes a user dataset 214ᵢ, a user key store 214₂, an object key store 214₃, an object dataset 214₄, and Augment Reality (AR) assets 214₅.

Initially, the user points a camera (not shown) of the augment reality apparatus 100 towards the object. The authentication engine 202 (or authentication services) validates the user by using the information available in the user dataset 214₁. After validating the user, a user identifier (ID) is sent to the user key generator 204. The user key generator 204 can be configured to generate a user key after receiving the user ID. In an embodiment, the user key is an n-bit unique key which is generated as a unique identifier or a pseudo random number. Further, the user key generator 204 can be configured to store the user key in the user key store 214₂ for further reuse. Further, the user key generator 204 can be configured to send the user key to the authorization engine 206. In an embodiment, the user key is dynamically generated by the user key generator 204 after authenticating the user, where the user key is generated based on at least one of a user identifier, a user behavior, and information of the object required by the user. In an embodiment, the user key can be dynamically changed with a new user key within an AR session.

When the user points the camera towards the object, the object detector and recognizer 208 detects the object. Further, the object detector and recognizer 208 can be configured to determine a match between the detected object and objects stored in the object dataset 214₄. After determining the match for the detected object from the object dataset 214₄, an object identifier (ID) is sent to the object key generator 210. After finding a match for the object from the object dataset 214₄, an object ID is passed to the object key generator 210. The object key generator 210 can be configured to generate an object key. Further, the object key generator 210 stores the generated object key in the object key store 214₃ for further reuse; and sends the object key to the authorization engine 206. In an embodiment, the object key can be dynamically generated by the object key generator 210 after recognizing the object pointed by the augment reality apparatus 100, where the object key is generated based on at least one of the object ID and information of the object. Further, the object key can be dynamically changed with a new object key within the AR session.

After receiving the user key and the object key, the authorization engine 206 can be configured to determine an authorization level based on the user key and the object key, where the authorization level identifies a role of the user and information about the object to be published based on the role of the user. The object key and the user key generate the required asset information for augmenting. Further, the authorization engine 206 can be configured to send the authorization level and the asset information to the overlay manager 212. The overlay manager 212 can be configured to cause to display the information associated with the object based on the role of the user on the augment reality apparatus 100. Unlike conventional systems and methods, the proposed method enables displaying different information of the same object to different users, thereby enabling a control over the information displayed to multiple users.

In an embodiment, an electronic device (i.e., mobile phone) is provided for augmenting information in an AR session based on role of a user. In an example, the mobile phone is used with an application running on it. If the user accesses the application and points the camera of the mobile phone towards an object, then the information appended to the object is viewed by the user. In another example, a head mounted display (HMD) is used to view the information appended to the object as described above.

In an example, consider a scenario where the user is undergoing a virtual tour of a fort. In this case, if the user points their camera towards an area (or room), then the user can view only information related to history of that room, area of the room, person lived in the room, or the like. Further, the user cannot able to view the information related to secret paths associated with the rooms, secret windows, or the like. Similarly, if a fort manager points their camera towards the same area, then the fort manager can view the information which is displayed to the user. Additionally, the fort manager can be able to view all the information pertaining to that room such as secret paths associated with the rooms, secret windows, or the like.

The FIG. 1 shows the system but it is to be understood that other embodiments are not limited thereon. In other embodiments, the system may include less or more number of units. Further, the labels or names of the units are used only for illustrative purpose and does not limit the scope of the invention. One or more units can be combined together to perform same or substantially similar function in the system.

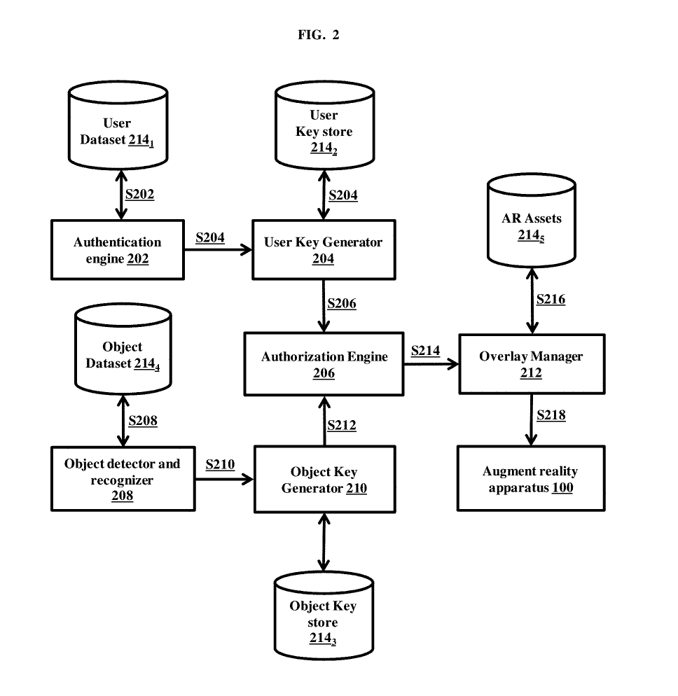

FIG. 2 is an example illustration for authorizing the user of the augment reality apparatus 100, according to an embodiment as disclosed herein. At step S202, initially, consider a scenario in which the user points his/her camera towards the object. The authentication engine 202 validates the user by using the user dataset 214₁.

At step S204, after validating the user, the user ID is passed to the user key generator 204 by the authentication engine 202. Unlike conventional systems and methods, after receiving the user ID, the user key generator 204 generates the user key and stores the same in the user key store 214₂ for further reuse.

At step S206, the user key generator 204 sends the user key to the authorization engine 206.

At step S208, when the user points the camera of the augment reality apparatus 100 towards the object, the object detector and recognizer 208 detects the object and compares the detected object with the objects stored in the object dataset 214₄.

At step S210, after determining the match for the object from the object dataset 214₄, the object ID is sent to the object key generator 210. Unlike conventional systems and methods, after receiving the object ID, the object key generator 210 generates the object key and stores the same in the object key store 214₃ for further reuse.

At step S212, the object key generator 210 sends the object key to the authorization engine 206. The authorization engine 206 receives the object key and the user key to generate the authorization level for the user and the object during the AR session. The object key and the user key generate the required asset information for augmenting.

At step S214, the authorization engine 206 sends the authorization level and the asset information to the overlay manager 212.

At step S216, the overlay manager 212 fetches AR assets 214₅ stored in the AR assets 214₅ for the object.

At step S218, the overlay manager 212 augments the AR assets 214₅ on the object which is then displayed on the augmented reality apparatus 100, based on the user's role. Unlike conventional systems and methods, the overlay manager 212 displays the information associated with the object based on the role of the user on the augment reality apparatus 100.

The various steps in the example illustration may be performed in the order presented, in a different order or simultaneously. Further, in some embodiments, some of the steps may be omitted, added, modified, skipped, or the like without departing from the scope of the invention. Further, in some of the embodiments, some of units may be omitted, added, modified, skipped, or the like without departing from the scope of the invention.

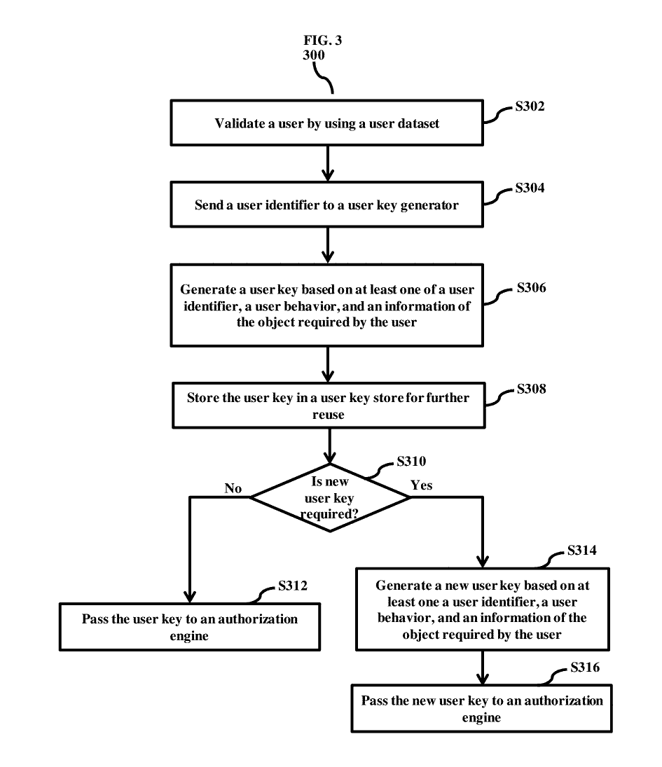

FIG. 3 is a flow diagram 300 illustrating various operations for generating and sending the user key to the authorization engine 206, according to an embodiment as disclosed herein. At step S302, the method includes validating the user by using the user dataset 214₁. The method allows the authentication engine 202 to validate the user by using the user dataset 214₁. At step S304, the method includes sending the user ID to the user key generator 204. The method allows the authentication engine 202 to send the user ID to the user key generator 204.

At step S306, the method includes generating the user key based on the at least one of the user identifier, the user behavior, and the information about the object required by the user. The method allows the user key generator 204 to generate the user key based on the at least one of the user identifier, the user behavior, and the information of the object required by the user. At step S308, the method includes storing the user key in the user key store 214₂ for further reuse. The method allows the user key generator 204 to store the user key in the user key store 214₂ for further reuse.

At step S310, if it is determined that the new user key is not required, then at step S312, the method includes passing the user key to the authorization engine 206. The method allows the user key generator 204 to pass the user key to the authorization engine 206. At step S310, if it is determined that the new user key is required, then at step S314, the method includes generating the new user key based on the at least one of the user ID, the user behavior, and the information of the object required by the user. The method allows the user key generator 204 to generate the new user key based on the at least one of the user ID, the user behavior, and the information of the object required by the user. In an example, the new user key is generated for dynamically changing the authorization level or role of the user within the AR session.

At step S316, the method includes passing the new user key to the authorization engine 206. The method allows the user key generator 204 to pass the new user key to the authorization engine 206.

The various actions, acts, blocks, steps, or the like in the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

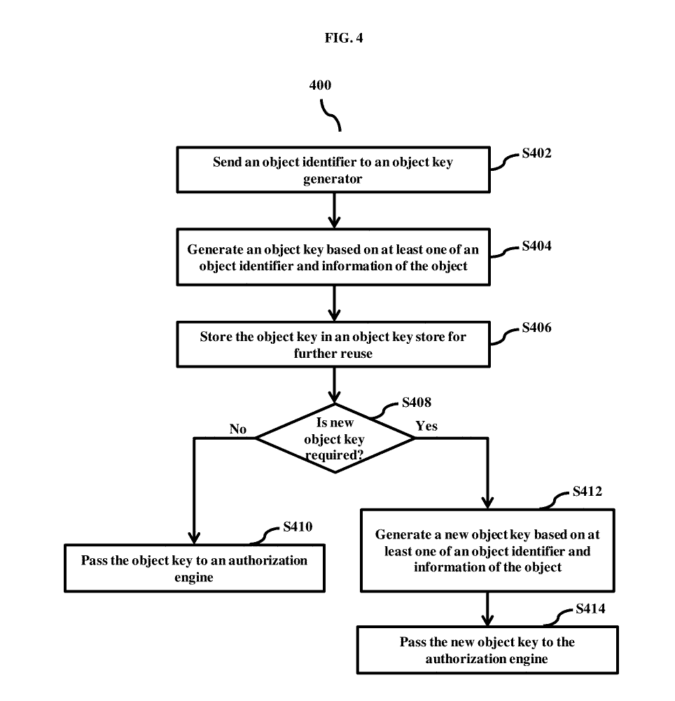

FIG. 4 is a flow diagram 400 illustrating various operations for generating and sending the object key to the authorization engine 208, according to an embodiment as disclosed herein. At step S402, the method includes sending the object ID to the object key generator 210. The method allows the object detector and recognizer 208 to send the object ID to the object key generator 210.

At step S404, the method includes generating the object key based on the at least one of the object ID and information of the object. The method allows the object key generator 210 to generate the object key based on the at least one of the object ID and information of the object. At step S406, the method includes storing the object key in the object key store 214₃ for further reuse. The method allows the object key generator 210 to store the object key in the object key store 214₃ for further reuse.

At step S408, if it is determined that the new object key is not required, then at step S410, the method includes passing the object key to the authorization engine 206. The method allows the object key generator 210 to pass the object key to the authorization engine 206. At step S408, if it is determined that the new object key is required, then at step S412, the method includes generating the new object key based on the at least one of the object ID and information of the object. The method allows the object key generator 210 to generate the new object key based on the at least one of the object ID and information of the object. In an example, the new object key is generated for dynamically changing the authorization level or role of the user within the AR session.

At step S414, the method includes passing the new object key to the authorization engine 206. The method allows the object key generator 210 to pass the new object key to the authorization engine 206.

The various actions, acts, blocks, steps, or the like in the flow diagram 400 may be performed in the order presented, in a different order or simultaneously. Further, in some embodiments, some of the actions, acts, blocks, steps, or the like may be omitted, added, modified, skipped, or the like without departing from the scope of the invention.

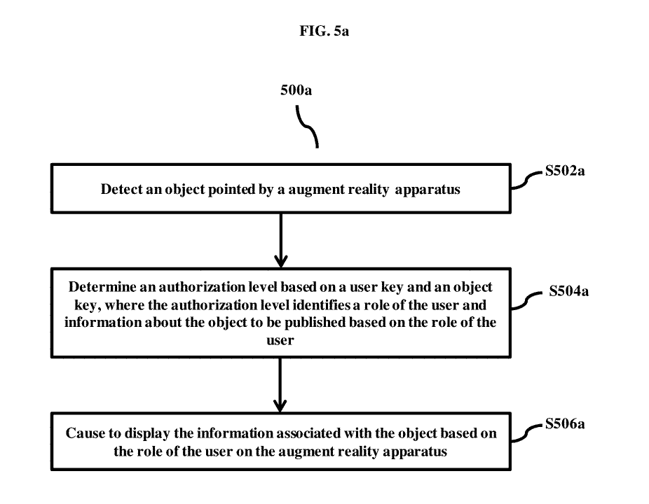

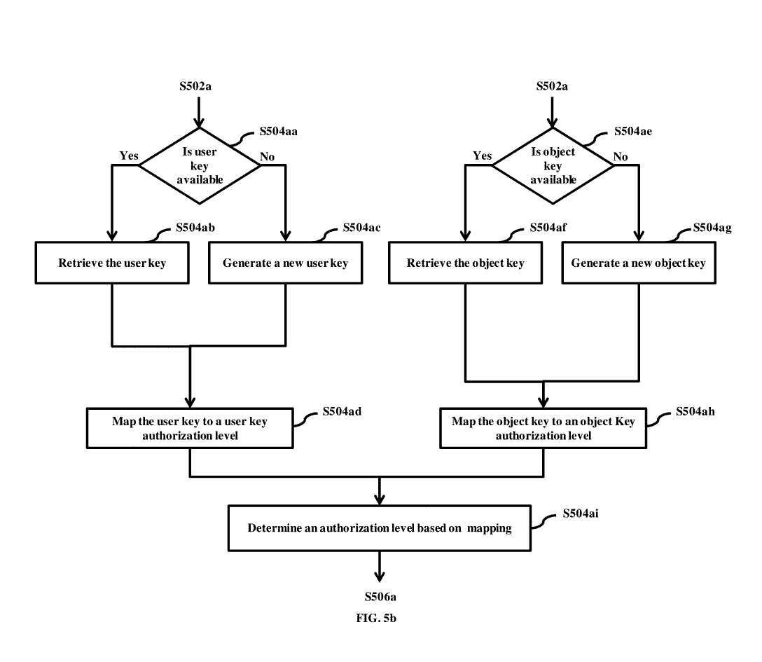

FIG. 5a is a flow diagram 500a illustrating a method for authorizing the user of the augmented reality apparatus 100, according to an embodiment as disclosed herein. At step S502a, the method includes detecting the object pointed by the augmented reality apparatus 100. The method allows the object detector and recognizer 208 to detect the object pointed by the augmented reality apparatus 100.

At step S504a, the method includes determining the authorization level based on the user key and the object key, where the authorization level identifies the role of the user and information about the object to be published based on the role of the user. The method allows the authorization engine 208 to determine the authorization level based on the user key and the object key, where the authorization level identifies the role of the user and information about the object to be published based on the role of the user.

In an embodiment, the user key is dynamically generated by the user key generator 204 after authenticating the user, where the user key is generated based on the at least one the user ID, the user behavior, and the information of the object required by the user. In an embodiment, the user key is dynamically changed with the new user key within the AR session. In an embodiment, the object key is dynamically generated by the object key generator 210 after recognizing the object pointed by the augment reality apparatus 100, where the object key is generated based on at least one of the object identifier and the information of the object. In an embodiment, the object key is dynamically changed with the new object key within the AR session.

At step S506a, the method includes causing to display the information associated with the object based on the role of the user on the augmented reality apparatus 100. The method allows the overlay manager 212 to cause to display the information associated with the object based on the role of the user on the augmented reality apparatus 100.

Unlike conventional systems and methods, the proposed method and the information apparatus, in addition to performing the authentication (by any manner), authorizes the user to view the information of the object. Further, the information can be dynamically changed, for the user, based on the combination of object keys and user keys.

The various actions, acts, blocks, steps, or the like in the flow diagram 500a may be performed in the order presented, in a different order or simultaneously. Further, in some embodiments, some of the actions, acts, blocks, steps, or the like may be omitted, added, modified, skipped, or the like without departing from the scope of the invention.

FIG. 5b is a flow diagram 500b illustrating a method for determining the authorization level based on the user key and the object key, according to an embodiment as disclosed herein. At step S504aa, if it is determined that the user key is available then, at step S504ab, the method includes retrieving the user key from the user key store 214₂. The method allows the user key generator 204 to retrieve the user key from the user key store 214₂. At step S504aa, if it is determined that the user key is unavailable then, at step S504ac, the method includes generating the new user key. The method allows the user key generator 204 to generate the new user key.

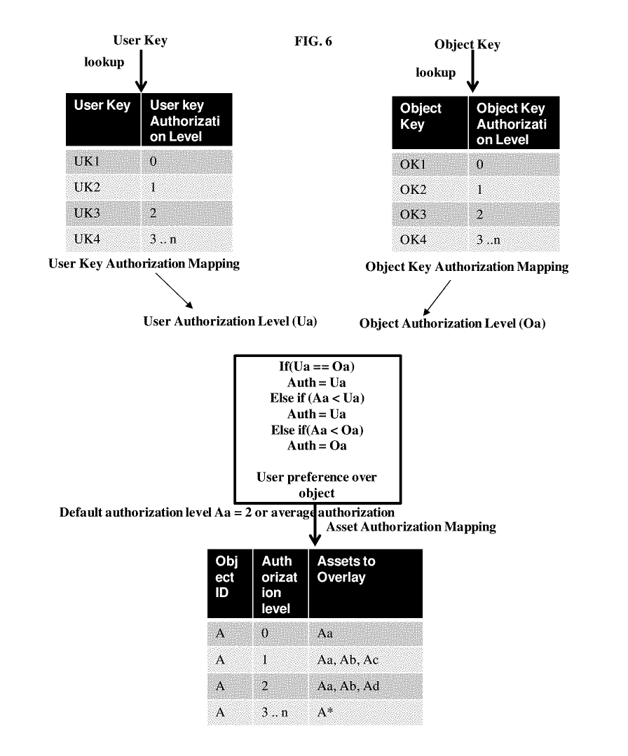

At step S504ad, the method includes mapping the user key to a user key authorization level as shown in FIG. 6. The method allows the authorization engine 206 to map the user key to the user key authorization level. At step S504ae, if it is determined that the object key is available, then at step S504af, the method includes retrieving the object key from the object key store 214₃. The method allows the object key generator 210 to retrieve the object key from the object key store 214₃. At step S504ae, if it is determined that the object key is unavailable, then at step S504ag, the method includes generating the new object key. The method allows the object key generator 210 to generate the new object key.

At step S504ah, the method includes mapping the object key to an object key authorization level. The method allows the authorization engine 206 to map the object key to the object key authorization level as shown in the FIG. 6. At step S504ai, the method includes determining the authorization level based on the mapping. The method allows the authorization engine 206 to determine the authorization level based on the mapping.

The various actions, acts, blocks, steps, or the like in the flow diagram 500b may be performed in the order presented, in a different order or simultaneously. Further, in some embodiments, some of the actions, acts, blocks, steps, or the like may be omitted, added, modified, skipped, or the like without departing from the scope of the invention.

FIG. 6 is an example illustration for dynamically changing the authorization levels of the users for selecting the information to be displayed on the augment reality apparatus 100, according to an embodiment as disclosed herein. In an embodiment, consider a scenario where an administrator (admin) needs to provide information to the user, during the same AR session. The user key generator 204 searches for the user key with the required authorization level from table as shown in the FIG. 6 and replace the existing user key with the new user key.

If the user key is unavailable in the user key store 214₂, as explained earlier, the unique n-bit key or the pseudo random number is generated and mapped to the user key authorization level. Further, if the admin needs to provide more or less information to the object, during the same AR session. The object key generator 210 searches for the object key with the required authorization level and replaces the existing object key with the new object key. If the object key is unavailable in the object key store 214₃, as explained earlier, the unique n-bit key or the pseudo random number is generated and mapped to the object key authorization level.

Unlike conventional systems and methods, the authorization level can be controlled by the admin. Further, the admin can select different asset authorization during the AR session by intimating the user key generator 204 and the object key generator 210. The authorization engine 206 uses the key and determines the asset to be overlaid. Within the same session, the object key and the user key are remapped according to the required authorization selected for the AR session. Basically a key remap is performed to change the authorization level. If the same key is used, unless either of the other key (i.e., if the object key is same and the user key changes the authorization level changes). During a different AR session, if the required authorization level remains same, the same key is remapped. Or else if the authorization level is changed, a new key is mapped to the user or the object.

In an example, if the user enters his user ID and password and logs on to the application for the AR session. The user key is provided to the user for that session inside the application. The user key is used to determine the authorization level of the AR asset. The user initiates viewing the AR information on the object. During the session, the admin initiates to allow the user to view more information. For this, the admin requests the system to have authorization level for the user to view the AR asset. The authenticated user requires a different authorization level to view the additional information about the object. Hence, the user key generator maps the new user key to the user. The user key is swapped with the new user key, which determines the authorization level for the AR asset. During the AR session, the admin can make a request to change the level of information presented to a particular user, and so the user key can change for this purpose making the system more dynamic and responsive.

Unlike conventional systems and methods, the proposed mechanism provides access level or role based information of the same object to different users. The information can be selected based on access restrictions to different users or based on the authorization level of the users.

The conventional method and system describes about authenticating the user and not authorizing the user for viewing one or more augmented information. Unlike conventional systems and methods, the proposed method and system, in addition to authentication (by any manner), authorizes the user to view one or more augmented information of the object. The one or more augmented information can be dynamically changed, for a user, based on a combination of object keys and user keys.

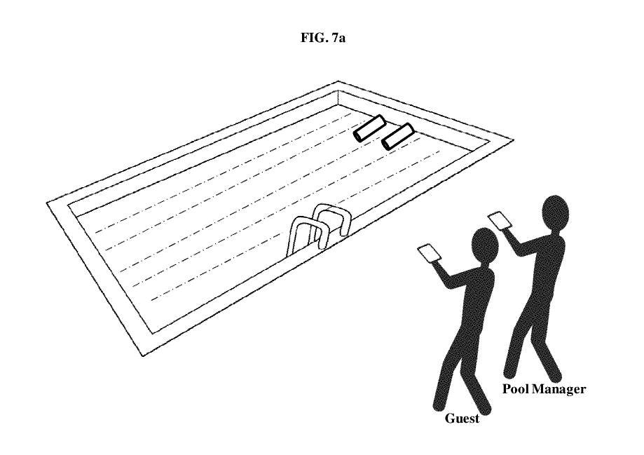

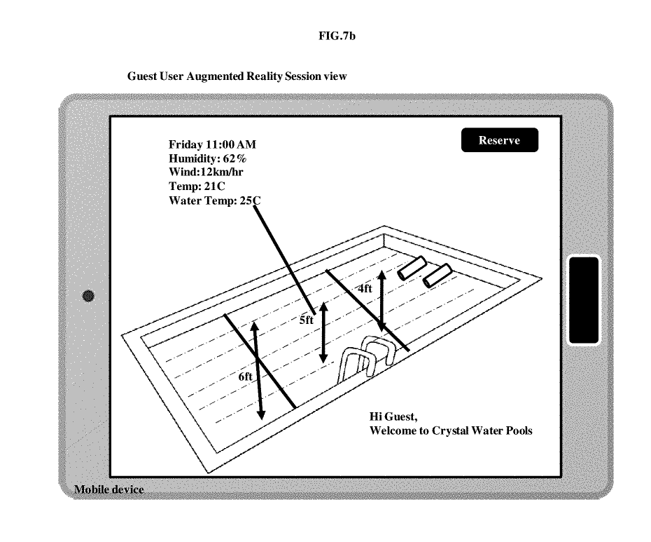

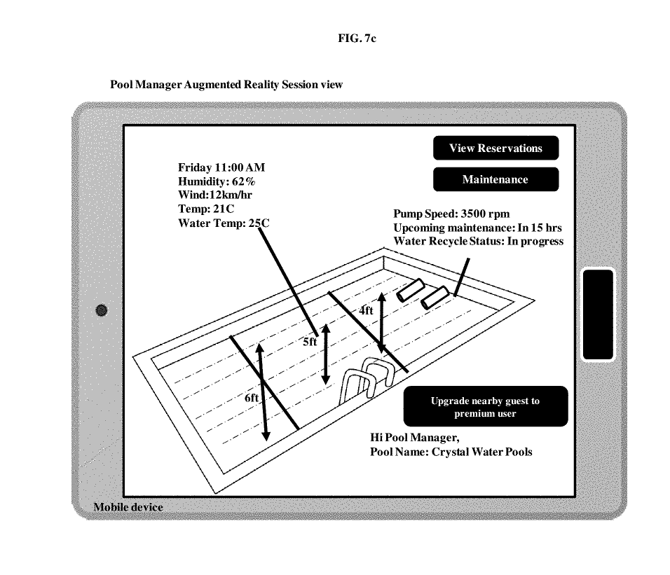

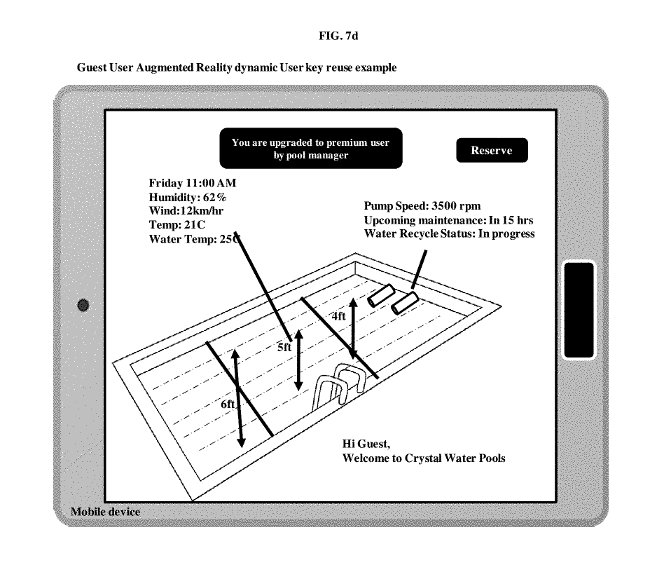

FIGS. 7a-7d is an example illustration in which a guest user and a pool manager viewing a swimming pool are displayed with the information associated with a swimming pool based on a role of the guest and the pool manager, according to an embodiment as disclosed herein. As shown in the FIG. 7a, consider a scenario in which the guest (or guest user) and the pool manager points their camera of the mobile device (i.e., augment reality apparatus 100) towards the swimming pool (i.e., the object). As shown in the FIG. 7b, based on the role of the guest user, the information such as depth of the swimming pool, date and time of a day, humidity, wind, temperature, and water temperature is displayed to the guest user on his/her mobile device in the AR session.

As shown in the FIG. 7c, based on the role of the pool manager, apart from the information displayed to the guest user, additionally, the information such as pump speed, upcoming maintenance, water recycle status, or the like are displayed to the pool manager on his/her mobile device in the AR session. If the guest user is upgraded to a premium guest user by generating the new user key by the pool manager, then as shown in the FIG. 7d, the information which is displayed to the pool manager is also displayed to the guest user within the same AR session. Unlike conventional systems and methods, role based augmented information of the same object is displayed to different users. Further, the information can be selected based on the access levels assigned to different users.

Although the proposed invention is explained in conjunction with the information apparatus 200. It is to be understood that the proposed method can be easily extended to head mounted displays or wearable devices which are capable of displaying augmented or virtual information without departing from the scope of the invention.

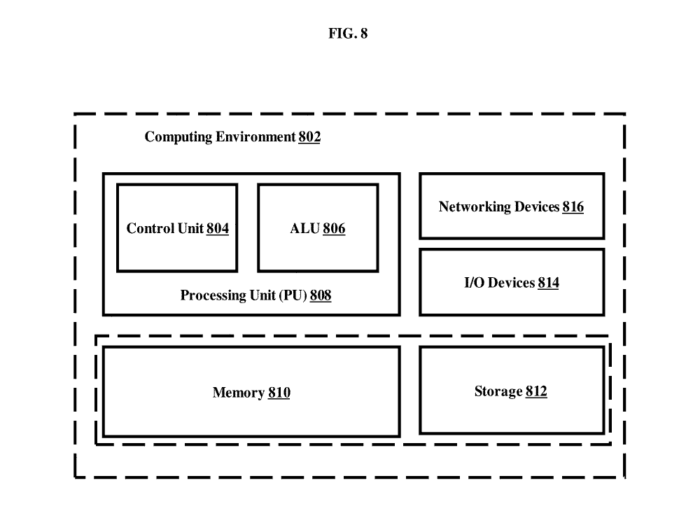

FIG. 8 illustrates a computing environment implementing the information apparatus and method for authorizing the user of the augment reality apparatus 100, according to an embodiment disclosed herein. As depicted in the FIG. 8, the computing environment 802 comprises at least one processing unit 808 that is equipped with a control unit 804 and an Arithmetic Logic Unit (ALU) 806, a memory 810, a storage unit 812, plurality of networking devices 816 and a plurality Input output (I/O) devices 814. The processing unit 808 is responsible for processing the instructions of the schemes. The processing unit 808 receives commands from the control unit 804 in order to perform its processing. Further, any logical and arithmetic operations involved in the execution of the instructions are computed with the help of the ALU 806.

The overall computing environment 802 can be composed of multiple homogeneous or heterogeneous cores, multiple CPUs of different kinds, special media and other accelerators. The processing unit 808 is responsible for processing the instructions of the schemes. Further, the plurality of processing units 808 may be located on a single chip or over multiple chips.

The scheme comprising of instructions and codes required for the implementation are stored in either the memory unit 810 or the storage 812 or both. At the time of execution, the instructions may be fetched from the corresponding memory 810 or storage 812, and executed by the processing unit 808.

In case of any hardware implementations various networking devices 816 or external I/O devices 814 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 8 include blocks which can be at least one of a hardware device, or a combination of hardware device and software units.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A computer-implement method for authorizing a user of an augment reality apparatus, the method comprising:
detecting, by an information apparatus, the object pointed by the augment reality apparatus;
determining, by the information apparatus, an authorization level based on a user key and an object key, wherein the authorization level identifies a role of the user and information about the object to be published based on the role of the user; and
causing, by the information apparatus, to display the information associated with the object based on the role of the user on the augment reality apparatus.

2. The method of claim 1, wherein determining the authorization level based on the user key and the object key comprises:
mapping the user key to a user key authorization level;
mapping the object key to an object key authorization level; and
determining the authorization level based on the user key authorization level and the object key authorization level.

3. The method of claim 1, wherein the user key is dynamically generated by the information apparatus after authenticating the user, wherein the user key is generated based on at least one a user identifier, a user behavior, and an information of the object required by the user.

4. The method of claim 1, wherein the user key is dynamically changed with a new user key within an augment reality session.

5. The method of claim 1, wherein the object key is dynamically generated by the information apparatus after recognizing the object pointed by the augment reality apparatus, wherein the object key is generated based on at least one of an object identifier and information of the object.

6. The method of claim 1, wherein the object key is dynamically changed with a new object key within an augment reality session.

7. An information apparatus for authorizing a user of an augment reality apparatus, the information apparatus comprising:
an authentication engine configured to authenticate the user of the augment reality apparatus;
an object detector and recognizer configured to detect an object pointed by the augment reality apparatus;
an authorization engine configured to determine an authorization level based on a user key and an object key, wherein the authorization level identifies a role of the user and information about the object to be published based on the role of the user; and
an overlay manager unit configured to cause to display the information associated with the object based on the role of the user on the augment reality apparatus.

8. The information apparatus of claim 7, wherein determine the authorization level based on the user key and the object key comprises:
map the user key to a user key authorization level;
map the object key to an object key authorization level; and
determine the authorization level based on the user key authorization level and the object key authorization level.

9. The information apparatus of claim 7, wherein the information apparatus comprises a user key generator configured to dynamically generate the user key after authenticating the user, wherein the user key is generated based on at least one a user identifier, a user behavior, and an information of the object required by the user.

10. The information apparatus of claim 7, wherein the user key is dynamically changed with a new user key within an augment reality session.

11. The information apparatus of claim 7, wherein the information apparatus comprises a user key generator configured to dynamically generate the object key after recognizing the object pointed by the augment reality apparatus, wherein the object key is generated based on at least one of an object identifier and information of the object.

12. The information apparatus of claim 7, wherein the object key is dynamically changed with a new object key within an augment reality session.

13. A computer program product comprising computer executable program code recorded on a computer readable non-transitory storage medium, said computer executable program code when executed causing the actions including:
detecting, by an information apparatus, an object pointed by an augment reality apparatus;
determining, by the information apparatus, an authorization level based on a user key and an object key, wherein the authorization level identifies a role of the user and information about the object to be published based on the role of the user; and
causing, by the information apparatus, to display the information associated with the object based on the role of the user on the augment reality apparatus.
